(19) United States
(12) Patent Application Publication
(10) Pub. No.: US 2021/0279692 A1
(43) Pub. Date: Sep. 9, 2021

(54) AUTOMATED CONTACT MANAGEMENT

(71) Applicant: TOCCA, INC., San Francisco, CA (US)

(72) Inventors: Tommaso Trionfi, San Francisco, CA (US); Stephane Paquet, Palo Alto, CA (US)

(21) Appl. No.: 17/253,468

(22) PCT Filed: Jun. 18, 2019
(86) PCT No.: PCT/US2019/037809

§ 371 Date: Dec. 17, 2020

Related U.S. Application Data
(60) Provisional application No. 62/816,843, filed on Mar. 11, 2019.
(60) Provisional application No. 62/753,455, filed on Oct. 31, 2018.
(60) Provisional application No. 62/686,223, filed on Jun. 18, 2018.

(51) Int. Cl. G06Q 10/10; H04L 29/06

(52) U.S. Cl. CPC G06Q 10/1095; H04L 63/0869

(57) ABSTRACT

A computing system is configured to facilitate the exchange and updating of contact information. Exchange of contact information may be facilitated by automatically generating a two-way exchange of information based on one-way communication of a single contact identifier. Exchange of contact information may be one part of a relationship between parties, the relationship further including logging of common events and locations visited. After exchange between parties, contact information is optionally automatically updated.

### CROSS-REFERENCE TO RELATED APPLICATIONS

This application is a 371 of PCT application Ser. No. PCT/US2019/037809 filed Jun. 18, 2019, which in turn claims priority to US provisional patent applications: 62/816,843 filed Mar. 11, 2019, 62/753,455 filed Oct. 31, 2018 and 62/686,223 filed Jun. 18, 2018. The disclosures of all the above applications are hereby incorporated herein by reference.

### BACKGROUND

### Field of the Invention

The invention is in the field of Automated Contact Management.

### Related Art

Contact information for a person includes information such as a person's name, telephone numbers, e-mail addresses, social media account identifiers, mailing addresses, title, demographics, marital status, age, gender, photograph, employment information, internet address, social security number, account number, and/or the like. Contact information for a legal entity can include information such as name, mail addresses, telephone numbers, e-mail address, entity type, state of registration, tax identifying number, social media account identifiers, internet addresses, employees, and/or the like.

Mobile device operating systems now include a capability to automatically recognize a 2D (two dimensional) barcode and identify vCard data embedded into the 2D barcode.

### SUMMARY

The communication of contact information is facilitated by encoding the contact information in a visual object, e.g., a 2D barcode or an image. The contact information can include, for example, that found in a vCard. Also, contact information can include social network account information such as a network link, user name or photograph or links to other (online of offline) materials. The visual object further includes an “exchange identifier” configured to track the contact information exchange. The exchange identifier can be an identifier unique to a specific transfer, to a specific time period (e.g., day, week, time of day or location), to a specific event, to receipt of contact information, to a recognized person, and/or to a received command. As such, the exchange identifier can be used to associate the transfer of the contact information with the characteristics to which the identifier is unique.

In some embodiments, a unique token is used to track a relationship. This relationship can be a 1-to-1 relationship, a one-to-many relationship or a many-to-many relationship. This token can be associated with events in a log (e.g., history) of the relationship, including for example the start of the relationship, communications between parties in the relationship, meetings between the parties, common events attended, and/or the like. In some embodiments, the token is configured to be used as an index to data records configured to store this information.

In an illustrative embodiment, contact information and an exchange identifier are encoded into a 2D barcode. The exchange identifier is associated with a location of a specific technical conference and time of day, and is unique to the conference and time of day. The 2D barcode is communicated visually to a third party, e.g., on a display of a smartphone. The exchange identifier can then be used to associate the contact information transfer with the location, conference and time. One value of this is that a user can then track who they provided contact information at the conference, which user were at the conference, which users interacted at the conference, etc.

In various embodiments, an exchange identifier can also be exchanged using non visual means such as URL, Wirelessly, optically, Sound, etc. The exchange identifier can also be exchanged using representations other than a 2D barcode. These representations include, for example, clouds of dots whose position and intensity are used to encode the exchange identifier. The exchange identifier is optionally represented using encryption layers to improve the exchange security or any other visual mechanism where position and or intensity or color is/are used to encode the message to be transmitted to the other party or parties.

Various embodiments of the invention include a system in which the one-way exchange of a token, such as a 2D barcode, alphanumeric code, and/or other identifier can result in a two-way exchange of contact information. These embodiments optionally include communication of the token from a mobile device to a server, where the provider and receiver of the token are both identified. Based on these identifications, both the sender and receiver are provided each other's contact information and the introduction is optionally logged as the start of a new relationship.

Various embodiments of the invention include a contact communication system comprising: an application including: identifier generation logic configured to generate a first unique exchange identifier, event identification logic configured to receive information regarding an event, code generation logic configured to generate a first machine readable code encoding the first unique exchange identifier and the information regarding the event, display logic configured to display the first code on a display of a mobile device, logging logic configured to generate a log of when or where the first code was displayed on the display, contact storage logic configured to store contact information of a user of the mobile device, optional contact reception logic configured to receive a second machine readable code from a third party, the second code encoding a second exchange identifier and contact information of the third party, optional communication logic configured to communication the first exchange code and the information regarding the event to a remote destination, and optional watermark logic configured to add a watermark to the first code; and a contact server including: log reception logic configured to receive the first exchange code and the information regarding the event from the mobile device via a communication network, user tracking logic configured to track events and exchange of contact information by the user, user connection logic configured to suggest introduction to third parties to the user, and user authentication logic configured to authenticate that the first exchange identifier was generated by the user.

Various embodiments of the invention include a contact communication system comprising: a computer executable application including: identifier generation logic configured to generate a first unique exchange identifier, event identification logic configured to receive information regarding an event, the event optionally including sending of an e-mail, text message or a social media connection, code generation logic configured to generate a first machine readable code encoding the first unique exchange identifier and the information regarding the event, placement logic configured to place the first code within a message, such as an e-mail, connection invitation or text message, logging logic configured to generate a log of when or where the first code was placed, contact storage logic configured to store contact information of a user of the mobile device, contact reception logic configured to receive a second machine readable code from a third party, the second code encoding a second exchange identifier and contact information of the third party, the contact reception logic may be configured to receive the second machine readable code via a camera or by parsing the message, and communication logic configured to communication the first exchange code and the information regarding the event to a remote destination; and a contact server including: log reception logic configured to receive the first exchange code and optionally the information regarding the event from the mobile device via a communication network, user tracking logic configured to track events and exchange of contact information by the user, user connection logic configured to suggest introduction to third parties to the user, and user authentication logic configured to authenticate that the first exchange identifier was generated by the user.

Various embodiments of the invention include a contact communication system comprising: storage configured to store contact information and relationships for a plurality of device users, the plurality of device users including a first party and a second party; user connection logic configured to receive information regarding an identity of the first party from the second party and to establish a two-way exchange of contact information between the first party and the second party, the two-way exchange including sending contact information of the first party to the second party and sending contact information of the second party to the first party; user authentication logic configured to determine that the information regarding the identity of the first party is authentic and has been provided to the second party by the first party; and log reception logic configured to log interactions between the first party and the second party.

Various embodiments of the invention include a method of communicating contact information, the method comprising: receiving a request to communicate contact information; selecting a set of contact information to communicate; receiving information regarding an event; generating a unique identifier; associating the unique identifier with the contact information and optionally the information about the event; generating an encoding the unique identifier and the contact information, the encoding optionally being a visible object; displaying the visible object or the like; logging transfer of the contact information, in a log of contact information transfer; and communicating the log of the transfer of the contact information to a remote device.

Various embodiments of the invention include a method of performing a two-way exchange of contact information based on a one-way exchange of a machine readable code, the method comprising: generating the machine readable code, the machine readable code regarding (e.g., being associated with or including) an identity of a first party; displaying the machine readable code on a display of a first device of the first party, or adding the machine readable code to a message to be sent by the first party; reading the machine readable code using a second device of a second party; sending information encoded in the machine readable code from the second mobile device to a contact management server; optionally authenticating the information sent to the contact management server as being sent by the first party to the second party; identifying both the first party and the second party at the contact management server; establishing a relationship between the first party and the second party, in response to receiving the information sent to the contact management server from the second device; sending the second party contact information of the first party, based on the established relationship; and sending the first party contact information of the second party, based on the established relations, thus achieving the two-way exchange of contact information.

### BRIEF DESCRIPTION OF THE DRAWINGS

FIG. 1 illustrates a contact communication system, according to various embodiments of the invention.

FIG. 2 illustrates a method of communicating contact information, according to various embodiments of the invention.

FIG. 3 illustrates methods of performing a two-way exchange of contact information based on a one-way exchange of a machine readable code between client devices.

### DETAILED DESCRIPTION

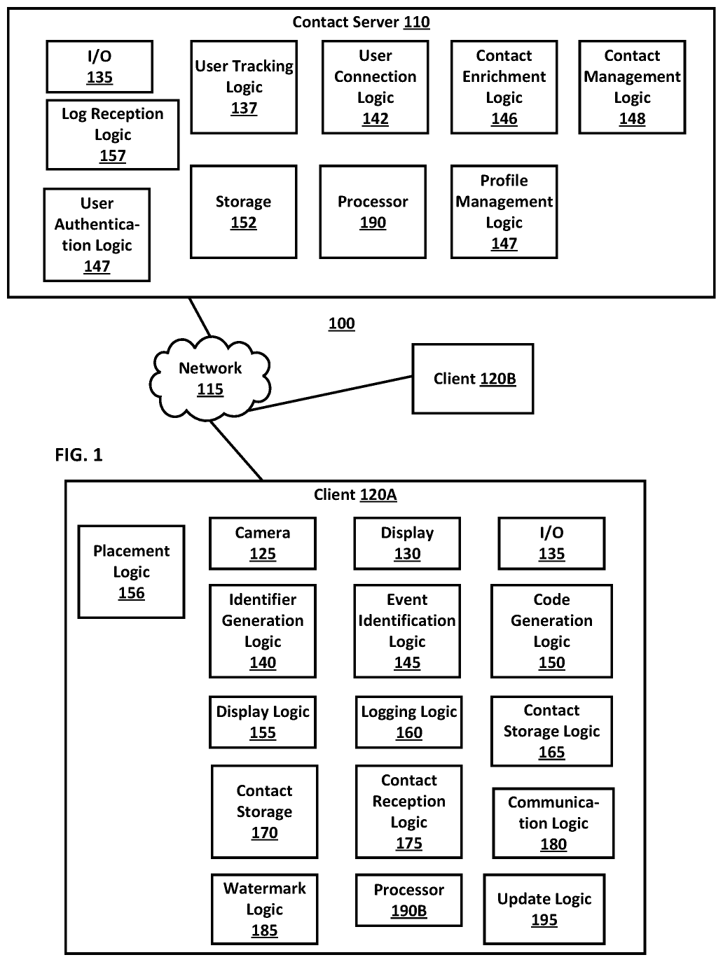

FIG. 1 illustrates a Contact Communication System 100, according to various embodiments of the invention. The Contact Communication System 100 aims at creating a strong and unique binding between individuals and businesses so that important information such as contact details can be kept permanently updated for all the connected parties. When one party updates his/her information, the changes are propagating to the other parties he/she agreed to share that information with, if the one party decides to do so. Further, in some embodiments, a user can update his or her information for just selected relationships. This approach may be used to terminate relationships by updating removing contact information. Updates are optionally performed automatically.

An application (optionally a mobile application) is configured to be executed on Clients 120, e.g., Client 120A or 120B. A Client 120A can be any electronic portable device such as a smartphone, tablet or watch that can be used to exchange contact information. Alternatively, Client 120A can be a desktop computer, web service, or other stationary computing device. The exchange of contact information is optionally performed via a wireless connection to a remote server, or in a peer-to-peer architecture.

Clients 120 optionally include a Camera 125. Camera 125 can be a still, video or 3D camera. Clients 120 include a Display 130. Display 130 can include a touch screen or non-touch screen.

Clients 120 include an I/O 135. I/O 135 can be wired or wireless, WiFi, Bluetooth, cellular, and/or the like. I/O 135 can include an antenna and circuitry configured for radio frequency communications. I/O 135, Camera 125 and Display 130 are optionally disposed within electronic glasses, a watch, a smartphone, a tablet computer, laptop, and/or the like.

The application includes Identifier Generation Logic 140 configured to generate a first unique exchange identifier, that is associated with context information such as date, time, location, etc. This association can include, for example, use of the unique exchange identifier as an index to a data record including the contact information. The identifier can be synchronized with the backend but not necessarily as it can also act like a RSA token. In that second option, RSA token like, the identifier is generated on a timely manner using a clock that has been previously synchronized with the backend infrastructure so that it is possible for the backend infrastructure to validate or invalidate a given identifier. Alternatively the identifier can be encrypted using mechanisms such as asymmetric encryption to validate a given identifier and protect any data it may contain.

Optionally, the first exchange identifier is unique to a day, time of day, location, meeting, event, conference, or single exchange of contact information. The first exchange identifier may be associated with a new relationship, in which case it is representative of a first event in that relationship. The relationship may be 1-to-1, 1-to-many or many-to-many. Optionally, the exchange identifier may be used as the identifier of a new relationship, rather than merely as an event. As the identifier of the relationship, the exchange identifier may be the token used to track the relationship and be used for deleting contact information (that has already been shared), changing shared contact information, tracking a log of relationship events, selecting which information should be shared in a relationship, and/or the like. As discussed further elsewhere herein, an exchange identifier can also be used to establish a two-way relationship based on a one-way exchange of the identifier.

Optionally the application further includes Event Identification Logic 145 configured to receive information regarding an event. Event Identification Logic 145 may be configured to identify events such as a meeting, conference, party, presentation, and/or the like. Optionally, Event Identification Logic 145 is configured to derive information regarding an event from an event scheduling system or a calendar entry. For example, Event Identification Logic 145 may be configured to retrieve event information from a Google calendar, an Outlook Calendar, meetup.com or eventbright.com, and/or the like. Or, may be configured to receive event information through manual user entry. The information can include location, time range, event title, and/or the like. Most of the information needed by the application is Calendar systems, but, we cross check information from calendars with publicly available data event sites such as eventbright.com, meetup to improve location accuracy.

The application further includes Code Generation Logic 150 configured to generate a first machine readable code. The machine readable code can include an identifier of a party providing the code, the first unique exchange identifier, and/or the information regarding the event. The first machine readable code optionally includes vCard data.

Optionally, the first machine readable code includes a 2D barcode or a dynamic barcode. A “dynamic” barcode that changes over time, e.g., includes more than one pattern displayed in less than 1, 2, 4 or 10 seconds. Optionally the dynamic barcodes change upon user request or upon specific actions from the user such as changing screen, requesting a new code, closing/opening the application on the mobile device, etc. This approach enables the use of technologies such as Apple Wallet as a media to support our technology. Optionally, the first machine readable code includes information encoded in the shape, the position, the intensity or the color of an object or group of objects presented in an image or an animation.

Optionally, Code Generation Logic 150 is configured to generate the first machine readable code including information sufficient to initiate a two-way exchange of contact information. This machine readable code includes or is associated with an identifier of a first party who provides the machine readable code to a second party. In embodiments wherein the first machine readable code includes is merely associated with an identifier of the first part, information embodied in the machine readable code is also sent from the Client 120 of the first party to Contact Server 110. At Contact Server 110, the code is identified as coming from the first party, either using the association between the information within the code and the identity of the first party or by extracting an identifier of the first party from the machine readable code. For example, an identifier of the first party may be retrieved from a storage based on a predetermined association between information in the code and the identifier. The received identifier or information in the code are optionally encrypted and/or configured for a single use. These operations are optionally performed by User Connection Logic 142. In some embodiments, the first machine readable code is configured to provide more information such as a Digital ID of a person, a payment mechanism, contact signing, strong authentication, access control and/or the like.

In these embodiments, the machine readable code is also received by Client 120B of the second party, as described elsewhere herein. At Client 120B an identifier of the second party (or information associated therewith) is combined with information derived from the first machine readable code and this combination is sent to Contact Server 110. At Contact Server 110, User Connection Logic 142 is used to establish a relationship between the first party and the second party, if the relationship does not already exist. The relationship is established based on receipt of the information and/or identifier from both parties, or on receipt of information identifying both the first party and the second party from the second party. Specifically, User Connection Logic 142 may relate receiving an identifier of the first party from the second party with the establishment of a relationship between the first party and the second party. In response, User Connection Logic 142 establishes the desired relationship and provides contact information of the first party to the second party, and also provides contact information of the second party to the first party. As such, a two-way exchange of contact information is established based on a one-way exchange of the machine readable code.

Contact Server 110 optionally further includes Contact Enrichment Logic 146. Contact Enrichment Logic 146 is configured to automatically enrich a user's profile by collecting information from sources such as social media accounts, websites, conference schedules, blogs, e-mail exchanges, and/or the like. The collected information can include locations, relationships, events, images, writings, titles, and/or the like. Information used by the Contact Enrichment Logic 146 can come from public or private sources. For example, private sources of information can be added and/or provided by one of the two or more parties involved in an exchange of contact information. The Enrichment Logic 146 is optionally used to provide an enriched vision of the contact. The collected information can be used, for example, as an icebreaker or to better position one of the party in the case of a sale engagement. Enrichment Logic 146 is optionally configured to alter the location where two or more parties met, by, for example replacing an address by the name of an event found in a calendar or an email.

Contact Server 110 optionally further includes Profile Management Logic 147. Profile Management Logic 147 is configured for a user to manage their profile. This management can include classifying which information is provided to which class and/or set of contacts. For example, in some embodiments, a user can select which information collected by Contact Enrichment Logic 146 is included in their profile. Further, a user can also remove this additional information from their profile at any time. Depending on the nature of the collected information, the information can also be removed from or replaced in the records of parties who have previously received it.

Contact Server 110 optionally further includes Contact Management Logic 148. Contact Management Logic 148 is configured for managing a user's contacts. For example, Contact Management Logic 148 can include automated classification of contacts. This classification is optionally performed using a trained machine learning system. The classification can include: investor, vendor, sales prospect, customer, co-worker, friend, family, supplier, and/or any class defined by the user. The classification may be based on any of the information in a contact's profile, e-mails or other messages, contact history between the user and their contact, and/or the like.

Any of Contact Enrichment Logic 146, Profile Management Logic 147, and/or Contact Management Logic 148 are optionally disposed on Clients 120. Client 120A optionally further includes Display Logic 155 configured to display the first code on a display of a mobile device, discuss that Display Logic 155 is optionally part of the application. Display Logic 155 can be configured to take user commands and display the machine readable code in response. A user of Client 120A can select which contact information to share with the user of Client 120B, e.g., business or personal information and/or specific data fields. The machine readable code may identify which information is to be shared, or an association between the information to be shared and the code may be provided to Contact Server 110.

Client 120 optionally further includes Placement Logic 156 configured to place the first code within a message to be sent from Client 120. This message can be, for example, an e-mail message, a text message, an invitation to connect on social media, and/or the like. Placement Logic 156 may be configured to place the first code within the message automatically and/or in response to a user command. Part of Placement Logic 156 may be disposed in an e-mail application, a text messaging application, a browser extension, and/or the like.

The machine readable code is optionally associated with a link or other address configured for a recipient to download the Display Logic 155 and/or Placement Logic 156. As such, the recipient may use the machine readable code to download any of the logic included in Client 120A.

Client 120A further includes Logging Logic 160 configured to generate a log of when or where the first code was displayed on the display, Log contains technical information which can be anonymized to provide data to improve the application or to offer usage statistics to the users. The log can contain information such as the device type, usage frequency, type of action triggered by the user, etc.

The application further includes Contact Storage Logic 165 configured to store contact information of a user of the mobile device, stored on mobile device, say what is in contact information. User can have multiple sets of contact information, e.g., personal or professional. Note: this part of the application also acts as a buffer between the backend and the contact directory in the smartphone. The contact details that are synchronized will also synchronized the contact directory that is part of the smartphone. As smartphones are becoming the node for all exchange, this will enable the synchronization of contact directories in other systems such as PC, tablets, etc. Typically, users can select which information (by category or by data field) is shared and/or synchronized in particular relationships. For example, if a user has a one to many relationship with a set of other users who were first contacted at a trade show, the user may designate that the information shared in this relationship should be limited to a business e-mail address.

The application optionally further includes Contact Reception Logic 175 configured to receive a second machine readable code from a third party, the second code encoding a second exchange identifier and contact information of the third party. This is the code to receive a code from a third party, split out the exchange code, log the information associate with an event, add to log, send exchange details to server, etc. In some embodiments, Contact Reception Logic 175 is configured to extract the machine readable code from a message such as an e-mail, text message, or connection invitation.

Client 120A optionally further includes Communication Logic 180 configured to communication the first exchange code and the information regarding the event to a remote destination. This can be part of the application. Communication Logic 180 can be configured to communicate over wireless connections, WiFi, cellular connections, wired connections, over cellular networks, the internet, optical connections, audio connections, and/or the like.

The application optionally further includes Watermark Logic 185 configured to add a watermark to the first code. The watermark optionally includes, for example, eye invisible distortions, QR code pixel color or color level changes, and/or introduction of filigree in the background. Inclusion of a layer, such as a watermark allows additional information to be passed between parties. For example, in the case of a financial transaction the identity of one party can be encoded as part of a “primary” Object and a watermark added to sign, identify, and/or quantify the transaction. Such approaches not only enable authentication of a party, but can also assure that the information has not been compromised or altered.

Client 120A optionally further includes Update Logic 195. Update Logic 195 is configured for a user to make selective updates to their contact information. In some embodiments, the user can specify which relationships are to receive an update. For example, the user may specify that only specific users are to receive an updated personal telephone number, and/or that specific users are not to receive an updated personal telephone number.

Contact Communication System 100 further includes a Contact Server 110. Contact Server 110 can include one or more web-based computing devices configured to communicate via a communication network, such as the internet. For example, in some embodiments, Contact Server 110 includes a cloud based computing system. Contact Server 110 is configured to communication with multiple Clients 120. In alternative embodiments, such as a peer-to-peer system, any or all of the features described herein as being included in Contact Server 110, are disposed in Client 120.

Contact Server 110 typically includes Log Reception Logic 157 configured to receive the first exchange code and the information regarding the event from the mobile device via a communication network. Log Reception Logic 157 is configured to store this information in a log. The log can be stored in a database record and/or may include plain text files. Logs are optionally encrypted or redacted to preserve user privacy. The logs can contain information about application performances, application usage, application analytics, and/or the like. The logs can also be used to report stability issue and ensure user security and privacy. In some cases, the logs can also be used to better configure the application and load balancing features thereof. Logs are optionally available to selected users for the purpose of reviewing the history of a relationship. For example, a first user may track when she first made contact with a second user and the times, dates and location of subsequent contacts. In some embodiments, logs include information derived from e-mails or text messages.

Contact Server 110 typically includes User Tracking Logic 137. User Tracking Logic 137 is configured to track events and exchange of contact information by the user. For example, User Tracking Logic 137 may be used to track when and where people connecting with each other, how active they are using the application and using features of the application, who introduced who to whom and why, the purpose of the introduction and more. User Tracking Logic 137 is used to track exchanges of information, including contact information, between a user and other users of Contact Communication System 100. Information collected by User Tracking Logic 137 is optionally stored in a log using Log Reception Logic 157.

Contact Server 110 optionally includes User Connection Logic 142. User Connection Logic 142 is configured to suggest introductions to third parties to the user, and connect the user with the persons he/she is sharing his/her identifier ID. As noted elsewhere herein, Connection Logic 142 is optionally configured to establish a two-way exchange of contact information based on a one way exchange of a machine readable code between two parties.

Introductions suggested by Connection Logic 142 can be based on locations, interests, event presence, and/or the like. Suggestions can also include secondary connections or people who have common interests or have been in touch (emails, else) in the past, or people who have related interests (e.g., one is hiring, one is looking for a job, etc.).

In some embodiments, Connection Logic 142 is configured to automatically make a 2-way connection (a 2-way exchange of contact information). Optionally, each user can define the data they want to share with the other, how to share the data and for how-long. Connections can be indefinite, temporary and/or single use only, as controlled by the origin of the share (who's introducing you to whom). 2-way connections may be initiated or established by a third party. Connection Logic 142 is optionally also configured to ensure that the users connecting to each other are entitled to do so and that the data exchanged between the parties is done with the consent of each of the parties. User Connection Logic 142 is optionally used to ensure security and privacy when users are exchanging information between each other. In some embodiments, Connection Logic 142 is configured to facilitate connections between more than two users at a time. For example, a teacher may be connected with all of her students, or all possible 2-way connections may be established between members of a group.

Contact Server 110 typically includes User Authentication Logic 147. User Authentication Logic 147 is configured to authenticate that the first exchange identifier was generated by the user. This authentication is optionally performed using a digital signature, an encrypted security certificate, a RSA like identifier, and/or the like. For example, User Authentication Logic 147 may be configured to use a private and public key pair in which the public key is used to encrypt data to be shared so that User Authentication Logic 147 can ensure that the receiving party is entitled to decrypt the data.

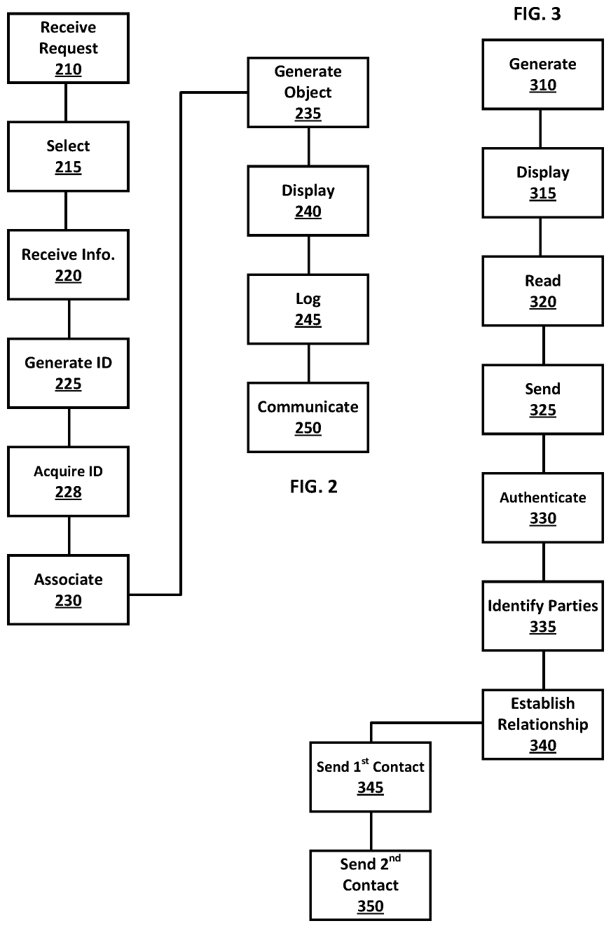

FIG. 2 illustrates a method of responding to a request for contact information, according to various embodiments of the invention. In this method, a request is received at a mobile device (e.g., Client 120A) of a user and a contact identifier is passed to a third party. This contact identifier is associated with contact information of the user and can be used to provide this contact information to a third party.

In a Receive Request Step 210 a request for contact information is received at the user's device. The user can trigger a request for contact information (voice, touch screen, keyboard or any other input mechanism supported by his/her mobile device) or a request can be triggered by an external event/system (wirelessly: NFC, Bluetooth, audio etc.).

In a Select Step 215 the user selects the contact information that is to be shared. This selection is generally performed by using the Display 130 or voice assistant interface. In Select Step 215 the user can, for example, select personal or business contact information. If the user does not select a contact identifier to be shared, a pre-selected one (default/preferred) is used. In some embodiments, the user may also define the nature or content of the information to be shared in using any given contact identifier.

In a Receive Info Step 220 information about the contact (names, phone, email, etc.) is received and context information is optionally acquired (location, time, etc.). In this step the transfer of the contact r may be associated with a specific event, such as a place or meeting. Associated logging is performed usually with Logging Logic 160. An example of Receive Info Sep 220 may include the receipt of information regarding an event a user is attending.

In a Generate ID Step 225 a contact identifier is generated. Generate ID Step 225 is optionally performed using Code Generation Logic 150. Associated logging is performed usually with Logging Logic 160. The contact identifier can be represented by a QR code or digital value. The contact identifier optionally contains the minimum information necessary for Contact Server 100 to identify the user providing the contact identifier. Using the generated contact identifier, additional information can be retrieved from Contact Management Logic 148 and/or Contact Enrichment Logic 146 using the contact identifier. The additional information is provided to each party using the User Connection Logic 142.

In a Transfer ID Step 228 the contact identifier is transferred to Contact Server 110. In alternative embodiments, the request is generated on Contact Server 110 and the contact identifier is transferred from Contact Server 110 and is transferred to Client 120A in this step.

In an Associate Step 230 the contact identifier is associated with a specific contact information exchange and the parties engaged in this exchange. This association may include setting the contact identifier as an index to a particular data record including any other information about the exchange. Associate Step 230 is optionally performed using User Connection Logic 142. In some embodiments, a contact identifier has a limited time period during which it can be used to complete a two-way exchange of contact information. In some embodiments, a contact identifier is limited to use in a specific geographic location.

In an optional Generate Object Step 235 an object, e.g., a QR code, including the contact identifier is generated. Step 235 is optional in embodiments in which the display isn't the means of communication. The generated object encodes information, e.g. the contact identifier, to be directly passed to the other party and information to be processed by the Contact Server 110 during and after the transaction. In alternative embodiments, the object includes an audio, electromagnetic or optical signal.

In an optional Display Step 240 the contact identifier, or object encoding the contact identifier, is displayed, e.g., using Display 130. In alternative embodiments, an audio, electromagnetic or optical signal is sent in Display Step 240. The contact identifier is thus provided to a second party, e.g., by reading the QR code. The second party acquires the contact identifier using, for example, Camera 125 or any compatible wired or wireless technologies.

In an optional Log Step 245 information regarding the exchange is logged. The log may be stored either in the Clients 120A/B or the Contact Server 110 generally performed using their respect log management logics. Log Step 245 is optionally performed using Log Reception Logic 157 and/or Logging Logic 160.

In a Communicate Step 250 the contact information of the first party is communicated to the second party, responsive to the second party being in possession of the contact identifier. (The first and second parties typically being two users/people exchanging contact information.) This communication can be from Contact Server 110 or from Client 120A. Connection between the users is generally confirmed either by using the Mobile Display 130 or via emails, etc. Communicate Step 250 may also include communicating the log of the transfer of the contact information to a remote device.

FIG. 3 illustrates methods of performing a two-way exchange of contact information based on a one-way exchange of a machine readable code between client devices. In these methods an exchange of a contact identifier is used to provide both the provider of the contact identifier and the recipient of the contact identifier with each other's contact information. Further, the contact information provided can be managed and updated as discussed elsewhere herein.

In a Generate Step 310, a contact identifier is generated. As in Generate ID Step 225, the generated contact identifier is optionally embodied in an object such as a machine readable code. The contact identifier being associated with or including an identity of a first party. The machine readable code can include a QR code, video or other form of a digital identifier. The contact identifier being associated with contact information of a first party providing the code. This Generate Step 310 may be preceded by Steps 210-220 discussed elsewhere herein.

In a Display Step 315 the machine readable code, or other object, generated in Generate Step 310 is displayed and/or otherwise communicated. This communication can be, for example, between Client 120A and Client 120B. In various embodiments, Step 315 can include broadcasting the contact identifier using a radio or optical signal, e.g., adding the machine readable code to a message to be sent by the first party. Optionally, wherein the machine readable code further includes authentication information configured to authenticate that the information encoded in the machine readable code was received from the first party by the second party. The authentication information optionally including a single use token. Display Step 315 is similar to Display Step 240.

In a Read Step 320, the contact identifier (optionally embodied in machine readable code) is read using a second device of a second party, e.g., using a radio receiver or a camera. This occurs on the mobile device of the second party, e.g., Client 120B. In various embodiments, Read Step 320 also includes authentication, compromising detection and other security mechanisms securing the data transfer and authenticating the source/recipient of the information.

In a Send Step 325, the contact identifier is sent to a contact management server, e.g., Contact Server 110. The contact identifier is from the second device of the second party, which received the contact identifier in Read Step 320. This step optionally also includes sending the contact identifier from the mobile device of the first party to Contact Server 110. These events are optionally logged using Logging Logic 160.

In an optional Authenticate Step 330, authenticating the information sent to the contact management server as being sent by the first party to the second party, this is done at Contact Server using User Authentication Logic 147.

In an Identify Parties Step 335, both the first party and the second party are identified at the contact management server, e.g., at Contact Server 110. Contact Management Logic 148 is used to identify the two (or more) parties between which contact information is to be exchanged. Optionally, Profile Management Logic 147 is used to determine which contact information is to be shared between the two or more parties, including but not only, enrich contact information, notes, contact details, etc.

In an Establish Relationship Step 340, a relationship is established between the first party and the second party. This relationship is established in response to receiving the information sent to the contact management server from the second device. Establish Relationship Step 340 is optionally performed using Contact Management Logic 148 and/or User Connection Logic 142. User Connection Logic 142 optionally uses the information received during Read Step 320 to validate that the Parties are allowed to connect with each other and are still sharing the required information to maintain a valid connection between the two (or more) parties.

In a Send First Contact Information Step 345, the contact information of the first party is sent to the second party, based on the established relationship. This contact information can include any additional information discussed herein, retrieved from Storage 152 by Profile Management Logic 147.

In a Send Second Contact Information Step 350, the contact information of the second party is sent to the second party, based on the established relations, thus achieving the two-way exchange of contact information. As discussed elsewhere herein, the contact information optionally includes much more than merely a simple identifier, such as a name, username or phone number. Further, even after being exchanged, the contact information may be automatically updated. The methods illustrated in FIG. 3 are optionally followed by Log Step 245, as discussed elsewhere herein.

The “logic” discussed herein includes hardware, firmware, and/or software stored on a non-transient computer readable medium. The logic includes (electronic) circuits configured to perform specific tasks for which the logic is configured. The embodiments discussed herein regarding mobile computing devices are optionally adapted to stationary computing devices.

Several embodiments are specifically illustrated and/or described herein. However, it will be appreciated that modifications and variations are covered by the above teachings and within the scope of the appended claims without departing from the spirit and intended scope thereof. For example, the systems and methods discussed herein can be used to facilitate financial transactions, in addition to or instead of exchanging contact information.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Computing systems referred to herein can comprise an integrated circuit, a microprocessor, a personal computer, a server, a distributed computing system, a communication device, a network device, or the like, and various combinations of the same. A computing system may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database. The various examples of logic noted above can comprise hardware, firmware, or software stored on a computer-readable medium, or combinations thereof. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

What is claimed is:

1. A contact communication system comprising:
an application including
identifier generation logic configured to generate a first unique exchange identifier,
event identification logic configured to receive information regarding an event,
code generation logic configured to generate a first machine readable code encoding the first unique exchange identifier and the information regarding the event,
display logic configured to display the first code on a display of a mobile device,
logging logic configured to generate a log of when or where the first code was displayed on the display,
contact storage logic configured to store contact information of a user of the mobile device,
optional contact reception logic configured to receive a second machine readable code from a third party, the second code encoding a second exchange identifier and contact information of the third party,
optional communication logic configured to communication the first exchange code and the information regarding the event to a remote destination, and
optional watermark logic configured to add a watermark to the first code; and
a contact server including
log reception logic configured to receive the first exchange code and the information regarding the event from the mobile device via a communication network,
user tracking logic configured to track events and exchange of contact information by the user,
user connection logic configured to suggest introduction to third parties to the user, and
user authentication logic configured to authenticate that the first exchange identifier was generated by the user.

2. A contact communication system comprising:
a computer executable application including:
identifier generation logic configured to generate a first unique exchange identifier,
event identification logic configured to receive information regarding an event, the event optionally including sending of an e-mail, text message or a social media connection,
code generation logic configured to generate a first machine readable code encoding the first unique exchange identifier and the information regarding the event,
placement logic configured to place the first code within a message, such as an e-mail, connection invitation or text message,
logging logic configured to generate a log of when or where the first code was placed,
contact storage logic configured to store contact information of a user of the mobile device,
contact reception logic configured to receive a second machine readable code from a third party, the second code encoding a second exchange identifier and contact information of the third party, the contact reception logic may be configured to receive the second machine readable code via a camera or by parsing the message, and
communication logic configured to communication the first exchange code and the information regarding the event to a remote destination; and
a contact server including:
log reception logic configured to receive the first exchange code and optionally the information regarding the event from the mobile device via a communication network,
user tracking logic configured to track events and exchange of contact information by the user,
user connection logic configured to suggest introduction to third parties to the user, and
user authentication logic configured to authenticate that the first exchange identifier was generated by the user.

3. A contact communication system comprising:
storage configured to store contact information and relationships for a plurality of device users, the plurality of device users including a first party and a second party;
user connection logic configured to receive information regarding an identity of the first party from the second party and to establish a two-way exchange of contact information between the first party and the second party, the two-way exchange including sending contact information of the first party to the second party and sending contact information of the second party to the first party;
user authentication logic configured to determine that the information regarding the identity of the first party is authentic and has been provided to the second party by the first party; and
log reception logic configured to log interactions between the first party and the second party.

4. The system of claim 1, wherein the information regarding the event is derived from an event scheduling system or a calendar entry

5. The system of claim 1, wherein the first machine readable code includes a 2D barcode or a dynamic barcode.

6. The system of claim 1, wherein the first machine readable code includes vCard data.

7. The system of claim 1, wherein the log is configured to store a date the code was displayed.

8. The system of claim 1, wherein the first identifier is unique to a day, time of day, location, meeting, event, conference, or single exchange of contact information.

9. The system of claim 1, wherein the placement logic configured to place the code in an e-mail message.

10. The system of claim 1, further comprising watermark logic configured to add a watermark to the first code.

11. The system of claim 1, wherein the event is a meeting, conference, single exchange of contact information.

12. The system of claim 1, wherein the information regarding the identity of the first party is communicated from the first party to the second party using a machine readable code, and further including contact reception logic disposed on a mobile device of the second party, the contact reception logic being configured to receive the machine readable code and to provide information encoded therein to the user connection logic via a communication network.

13. The system of claim 1, wherein the user connection logic is disposed on a contact server configured to communicate and manage contact information received from a plurality of devices, each of the mobile devices including:
identifier generation logic configured to generate a first unique exchange identifier,
event identification logic configured to receive information regarding an event,
code generation logic configured to generate a first machine readable code encoding the first unique exchange identifier and the information regarding the event,
display logic configured to display the first code on a display of a mobile device,
logging logic configured to generate a log of when or where the first code was displayed on the display, and
contact storage logic configured to store contact information of a user of the mobile device.

14. A method of communicating contact information, the method comprising:
receiving a request to communicate contact information;
selecting a set of contact information to communicate;
receiving information regarding an event;
generating a unique identifier;
associating the unique identifier with the contact information and optionally the information about the event;
generating an encoding the unique identifier and the contact information, the encoding optionally being a visible object;
displaying the visible object or the like;
logging transfer of the contact information, in a log of contact information transfer; and
communicating the log of the transfer of the contact information to a remote device.

15. A method of performing a two-way exchange of contact information based on a one-way exchange of a machine readable code, the method comprising:
generating the machine readable code, the machine readable code regarding (e.g., being associated with or including) an identity of a first party;
displaying the machine readable code on a display of a first device of the first party, or adding the machine readable code to a message to be sent by the first party;
reading the machine readable code using a second device of a second party;
sending information encoded in the machine readable code from the second mobile device to a contact management server;
optionally authenticating the information sent to the contact management server as being sent by the first party to the second party;
identifying both the first party and the second party at the contact management server;
establishing a relationship between the first party and the second party, in response to receiving the information sent to the contact management server from the second device;
sending the second party contact information of the first party, based on the established relationship; and
sending the first party contact information of the second party, based on the established relations, thus achieving the two-way exchange of contact information.

16. The method of claim 14, wherein the machine readable code further includes authentication information configured to authenticate that the information encoded in the machine readable code was received from the first party by the second party, the information optionally including a single use token.

17. The method of claim 14, further comprising receiving an update of the contact information of the first party and automatically sending the second party the update, based on the established relationship between the first party and the second party.

18. The method of claim 14, wherein the machine readable code includes a single use token.

19. The method of claim 15, wherein the machine readable code further includes authentication information configured to authenticate that the information encoded in the machine readable code was received from the first party by the second party, the information optionally including a single use token.

20. The method of claim 15, further comprising receiving an update of the contact information of the first party and automatically sending the second party the update, based on the established relationship between the first party and the second party.
